(19) United States
(12) Patent Application Publication
(10) Pub. No.: US 2007/0283342 A1
(43) Pub. Date: Dec. 6, 2007

(54) Dynamic Modularity In Flexible, Persistent Agents

(76) Inventors: Chris Anthony Reed, Dundee (GB); Richard Moynihan, Dundee (GB); Brian Boswell, Dundee (GB)

Correspondence Address: RATNERPRESTIA, P O BOX 980, VALLEY FORGE, PA, 19482-0980, US

(21) Appl. No.: 10/585,222

(22) PCT Filed: Dec. 30, 2004
(86) PCT No.: PCT/GB04/05459

§ 371 Date: Mar. 13, 2007

(30) Foreign Application Priority Data
Jan. 6, 2004 (GB) 0400148.3

(51) Int. Cl. G06F 9/445

(52) U.S. Cl. 717/174

(57) ABSTRACT

Apparatus and method for the dynamic deployment of functionality in software agents. The agent which represents a person's identity, is adapted to dock with a dockable module which includes a method means for performing a function. The agent also has an intermodule communication means for mapping a request from a requesting module to the method means in the dockable module. The invention provides efficient dynamic changes of modules in an agent and the capability to decouple modules in such a way that both data exchange and method calls can be executed without prior knowledge of anticipated functionality.

The present invention relates to software agents and in particular to the dynamic deployment of functionality in software agents.

Agents represent a means of representing a user in the electronic world, bringing together all the various functions that the user wants to perform in that electronic world, including:
transient, anonymous presence of an online search;
persistent occasional presence of online shopping at a particular store;
persistent passive presence of directed marking;
persistent though temporary realtime presence in an online game;
   and many more.

US Patent Application Publication Number US2002062334 to Hewlett Packard Company, CO, USA, entitled “Dynamic Agents for Dynamic Service Provision” teaches of dynamic agents and a dynamic agent infrastructure that supports dynamic behaviour modification of agents. One key limitation of the approach presented is that it refers to the dynamic deployment of agent behaviour.—However, for the system to work as described, that dynamically deployed behaviour must be predefined (so that individual programs can know what to expect from others). The term ‘dynamic’ is thus misleading. The work could better be described as the dynamic deployment of statically defined behaviour. One problem with US2002062334 is that software engineering in the large, and in particular, multi-party and multi-site development is made much harder by the need to conform to a rigid, pre-specified sets of functionality. It would be advantageous for new functionality to be definable dynamically, so that separate teams can worker more independently, thereby simplifying problem decomposition.

US2002062334 describes dynamic functionality in an agent. It does not decouple functionality and therefore does not support functionality that is not at least defined at agent start-up. It discloses that the dynamic agent's modifiable portion includes its data, knowledge and action programs, which determines its application specific capabilities. Thus the generic, fixed portion of a dynamic agent, together with its application programs, acts as an autonomous problem solver. This means that generic capabilities (such as reasoning) are fixed at the point of startup of an agent. For agents that persist over a long period (months and years, rather than hours or days) this means that it is impossible to introduce new, generic capabilities as they become available.

Also, US2002062334 does not explain how existing functionality might be replaced. Crucially, if demands are made of a carried action, and those demands pile up, and the carried action is then replaced, there is no way of co-ordinating the rescheduling of those demands for the new carried action. By having a specific component responsible for hand-over during update, it would become possible to queue these demands until the new functionality is in a position to handle them.

Agents represent individuals, and typically persist over long periods. It is thus a very real problem that adding new generic functionality and upgrading existing functionality in deployed systems should be prohibited. As a consequence, it would be advantageous to implement a method by which even the core, generic functionality can be replaced. A portion of the data of an agent may be retained, at the discretion of the update mechanism, to maintain coherence (so, for example, the beliefs of an agent may persist through an update of core functionality). This would allow upgrading of deployed agents through a straightforward, scalable mechanism.

US2002062334 discloses that when multiple actions are carried by the same dynamic agent, they can exchange information through the object store of that dynamic agent. However, for a carried action to be able to use data from another module, it must be able to anticipate the availability and internal structure of that data. That is, it must have knowledge of the “interface” provided by that action. So for any two actions that might need to interact, they must (a) know that the other action is carried, (b) know enough about that action to know what data it can provide and in what format. In this way, any ‘old’ carried action will be unable to exploit the functionality developed in ‘new’ carried actions that was unanticipated at the time of the development of the ‘old’ carried action. This is a clear theoretical problem that translates into a large practical problem in situations where agent systems are deployed on a wide basis, particularly if they are persistent, and subject to rigorous quality of service requirements (such that they can't simply be ‘switched off’ for an upgrade).

A second problem, in a similar vein, is that old actions cannot know of the methods (i.e. published procedures) of a newer carried action. It is presumably for this reason, and because it is much more difficult to design all possible method interfaces on a system-wide basis at the outset, rather than because of its data interfaces, that the disclosed system does not support method calls between carried actions. This reduces the potential for synergistic interplay between carried actions, and can lead to requiring redundancy (reimplementing identical functionality in different carried actions).

The problem is thus that one carried action cannot make a call upon the abilities of another. This violates key principles of modern programming practice aimed at code reuse and adaptation, by forcing modules to implement all the functionality that they will need, rather than utilising functionality they may know is already available within other modules in the agent.

It is an object of the present invention to provide efficient dynamic changes of modules in an agent and overcome at least some of the problems identified above.

According to a first aspect of the present invention, there is provided an agent for representing a person's identity adapted to dock a dockable module, the dockable module comprising a method means for performing a function, wherein the agent further comprises an intermodule communication means for mapping a request from a requesting module to the method means in the dockable module.

Preferably said method means is adapted to perform said function responsive to said request.

Preferably said request from the requesting module comprises a label specifying a function and said method means in said dockable module corresponds to the specified function.

Preferably said intermodule communication means comprises a store of labels and associated modules.

Preferably said store of labels and associated modules is a table.

Optionally said method means is adapted to perform the function of docking said dockable module with said agent.

Optionally said method means is adapted to perform the function of registering a label with said intermodule communication means, the label specifying a function supported by said dockable module.

Optionally said method means is adapted to perform the function of undocking said dockable module from an agent.

Optionally said method means is adapted to perform the function of requesting the discarding of a label from the intermodule communication means, the label specifying a function supported by said dockable module.

Optionally said method means is adapted to perform the function of updating said dockable module within said agent.

According to a second aspect of the present invention, there is provided a method of deployment of a module in an agent comprising the steps of:

receiving a request for deployment of said module;

maintaining registration information relating to a function supported by said module; and

invoking said function.

Preferably said step of maintaining registration information comprises maintaining a store of labels and associated modules, each label specifying a function supported by a module.

Preferably said store of labels and associated modules is a table.

Preferably said step of maintaining registration information comprises the step of registering a label specifying a function supported by said module.

This is a final step in the docking process.

Alternatively said module is a docked module and said step of maintaining registration information comprises the step of unregistering a label specifying a function supported by said docked module.

This is a final step in the undocking process. Alternatively said module is a replacement module and said step of maintaining registration information comprises the steps of:
unregistering a label specifying a function supported by a docked module from said agent; and
registering a label specifying a function supported by said replacement module with said agent
   and said method further comprises the steps of:
storing information related to the state of said docked module; and
instantiating said replacement module using said stored information.

These constitute steps in the process of updating.

Optionally, said step of maintaining registration information further comprises the step of queuing calls to the docked modules, registered labels, prior to the step of registering a label specifying a function supported by said replacement module.

Preferably, said function supported by said module is the method of deployment of said module.

According to a third aspect of the invention there is provided a computer program comprising program instructions for causing a computer to perform the method of claims 11 to 18.

In order to provide a better understanding of the present invention, an embodiment will now be described by way of example only and with reference to the accompanying Figures, in which:

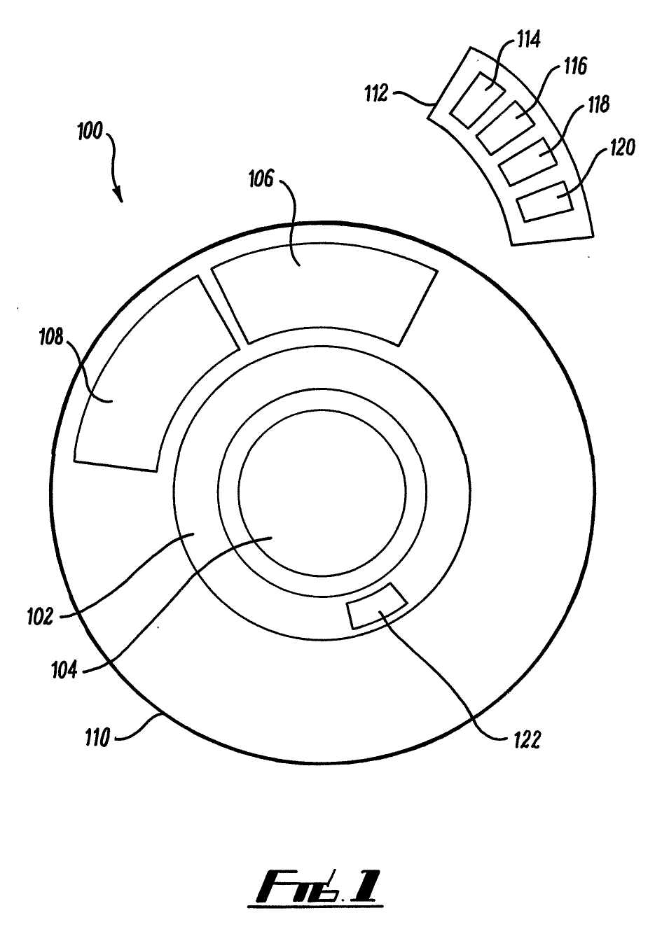

FIG. 1 illustrates, in schematic form, an agent and a module in accordance with a preferred embodiment of the present invention;

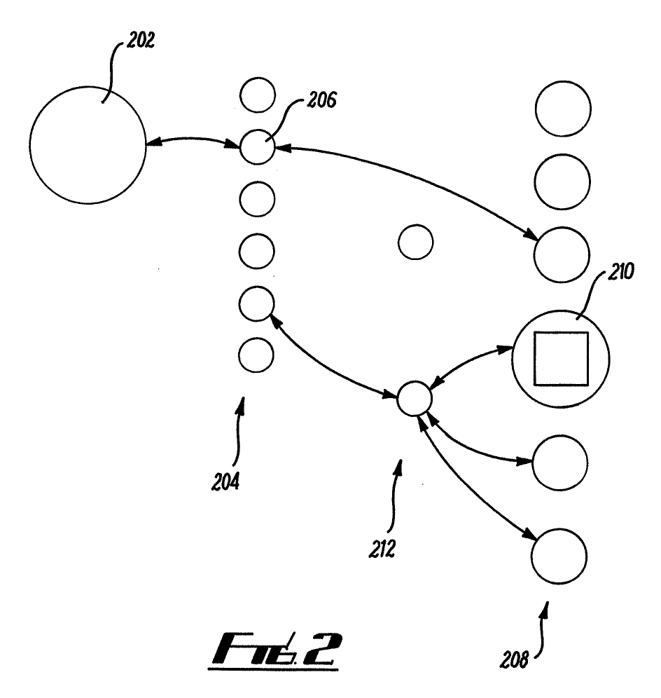

FIG. 2 illustrates, in schematic form, an overview of agentative representation in a multi-service environment;

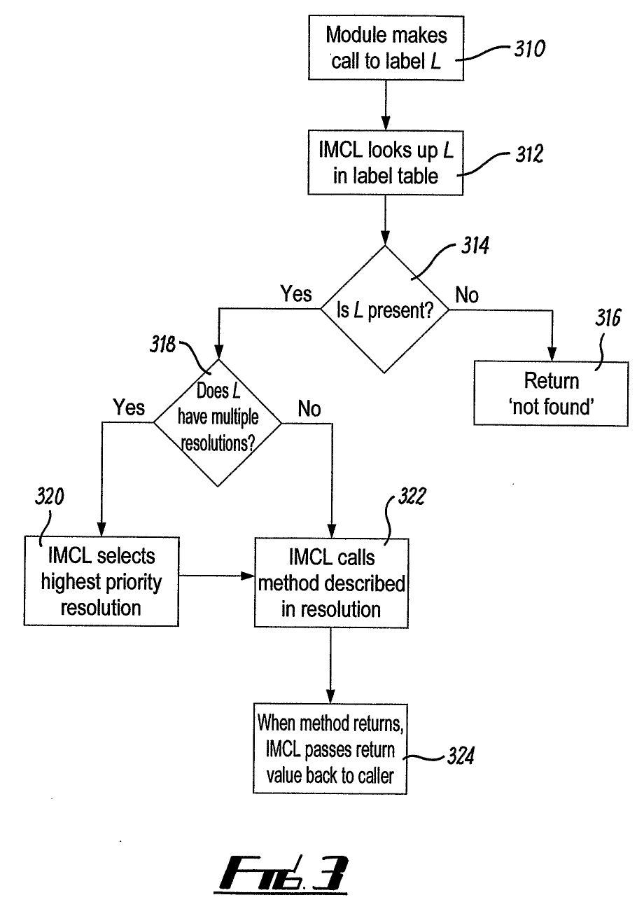

FIG. 3 illustrates, in schematic form, the process by which a label is resolved in accordance with a preferred embodiment of the present invention;

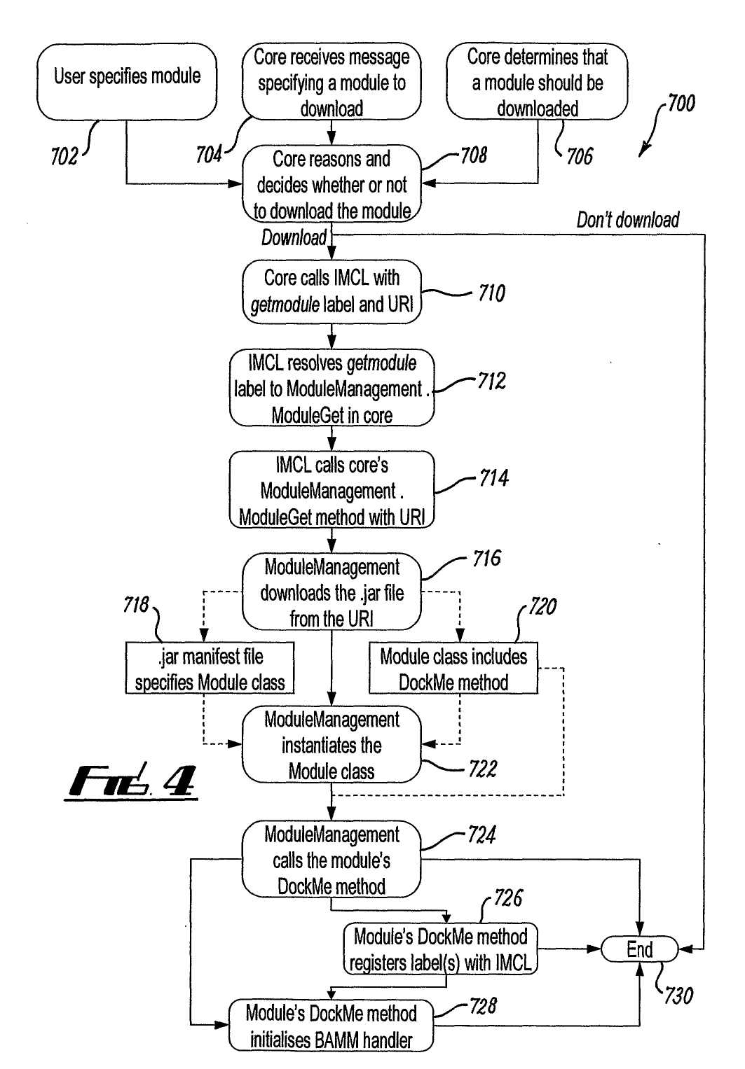

FIG. 4 illustrates, in schematic form, module docking in accordance with the present invention;

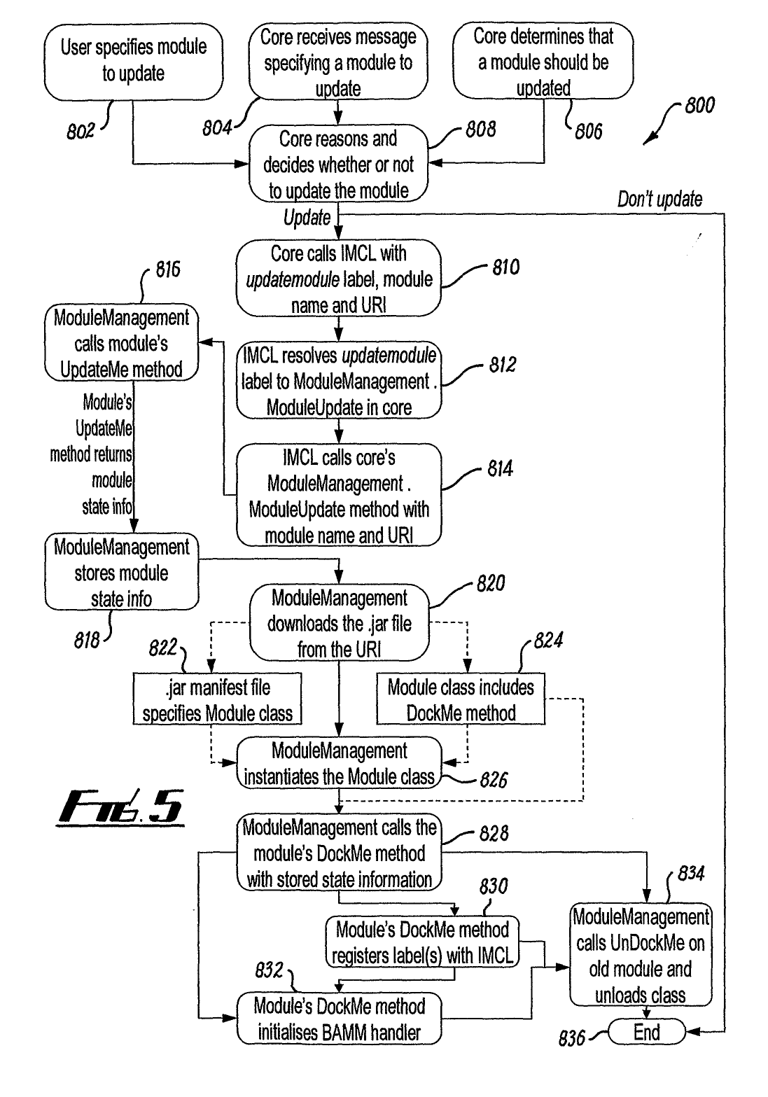

FIG. 5 illustrates, in schematic form, module updating in accordance with the present invention;

The inventions are an architecture and methods for dynamic deployment of modules in a software agent.

Although the embodiments of the invention described with reference to the drawings comprise computer apparatus and processes performed in computer apparatus, the invention also extends to computer programs, particularly computer programs on or in a carrier, adapted for putting the invention into practice. The program may be in the form of source code, object code, a code of intermediate source and object code such as in partially compiled form suitable for use in the implementation of the processes according to the invention. The carrier may be any entity or device capable of carrying the program.

For example, the carrier may comprise a storage medium, such as ROM, for example a CD ROM or a semiconductor ROM, or a magnetic recording medium, for example, floppy disc or hard disc. Further, the carrier may be a transmissible carrier such as an electrical or optical signal which may be conveyed via electrical or optical cable or by radio or other means.

When the program is embodied in a signal which may be conveyed directly by a cable or other device or means, the carrier may be constituted by such cable or other device or means.

Alternatively, the carrier may be an integrated circuit in which the program is embedded, the integrated circuit being adapted for performing, or for use in the performance of, the relevant processes.

With reference to FIG. 1, the architecture 100 of an agent according to the present invention is best visualised as including a torus. On the inside of the torus 102, a special module, the core module 104, attaches itself. On the outside of the torus, any number of application specific modules 106, 108 may also become attached. The security and unity of the agent is also conceptually protected by a thin sphere 110 encompassing all the modules. The torus itself coordinates all communication between modules and between modules and core: this is the Inter Module Communication Layer (IMCL).

The modular architecture is implemented as a class that defines a module, from which specific classes, corresponding to modules with specific functionality, can be derived. A module 112 is shown with its components depicted. The module contains a number of components for implementing functions:
1. A docking method 114 that is called when the module is introduced to the agent and that describes the functionality provided by that module;
2. An undocking method 116 that is called when the module is required to detach itself from the agent and terminate;
3. An update method 118 that is called when the module is to be updated with a new version; and
4. A set of message handling method 120 for between-agent communication.

The docking method of a particular module provides the IMCL with a list of labels. The extensible set of these labels is consistent system-wide, functioning as the definition of the system's programming interface and is maintained centrally by the service provider. A particular module implements methods that match some (typically small) subset of all labels. On docking, a module informs the IMCL which labels it provides functionality for. As each module docks, the IMCL builds a table 122 of labels against which are listed the names of the methods that provide the functionality and the names of the modules implementing those methods.

In some cases, the labels implemented by a particular newly docking module may already be implemented by methods extant in the agent. So for example functionality implemented by method x in module m1 may mean that when m1 docks in an agent, it needs to register the label f with the IMCL. But some other method, y, in some other module, m2, that is already docked, may also implement functionality f. Thus the IMCL would list functionality f has being implemented by m2.y.

In such situations, the IMCL adds the new label and associated method to its table, but also includes a priority ranking, applied to both the new and old methods that implement the functionality. This priority is determined on the basis of some algorithm. Recency is a good example, whereby newer methods are always given a higher priority, but there are many such algorithms.

In addition, a module's docking method calls functions provided by the core's module management. These calls register information about the module with the core, including its name, provenance and labelled functionality.

A user interacts with the electronic world for a host of reasons in a wide variety of domains: entertainment, e-commerce, professional, and so on. The present invention provides a means of bringing together all of these tasks and domains, and providing a single point of contact for the user, and allowing the sharing of user data between these different application domains. This contact is the user's agent, both in the computer-science sense (where agent oriented programming has particular restrictions, techniques and approaches, and places particular demands on software), and also in the intuitive sense of providing services of advocacy and representation. A user's agent is their permanent representative in the electronic world. Ideally, each user has exactly one agent, and a user's agent represents exactly one user (at the very least, such a relationship exists in a given context). The overall picture is as in FIG. 2.

With reference to FIG. 2, an overview of agentative representation in a multiservice environment is shown. The user 202 connects to their agent 206 at any time via any device (2G phones, multimedia mobile handsets, internet-capable hardware, etc.) in ways that are well known. The user agents 204 which represent users in the virtual world are shown. One user has a single agent 206 representing him or her in all their interactions in the virtual world. The service agents 208 provide specific services to any agents that request them, or that the service agents themselves decide to service. Information exchange between user and service agents can be initiated from either end. Some service agents 210 encapsulate existing legacy services (e.g., databases, Web Services and proprietary data handling systems). Broker agents 212 can mediate between a user and service agents. The user agents service agents and broker agents may be provided as a trusted service by a telecommunications operator.

An agent is a software entity with particular characteristics. We refer here to software processes that are:

persistent (in that they continue to exist for an extended real time period, adapting to a single user over that time);

proactive (in that they include not only reactive behaviour, but also independently determined behaviour);

communicative (in that they communicate with other agents); and

autonomous (in that they typically cannot be directly modified by outside agencies, but must instead be altered through communication).

The user can communicate with his agent across heterogeneous networks from a variety of devices, including mobile handsets and internet clients. In addition, however, the framework of the present invention supports the transparent filtering of information according to the device to which it is being sent. Thus the components within an agent that initiate communication with a user need not have any representation of the device type a user is employing. The content of the message is instead dynamically tailored to the user's device (e.g. summary text to an SMS-enabled mobile device, still pictures to a MMS-enabled mobile device, streaming video to broadband internet client platform, etc.).

The core is responsible for tailoring information to the device that is known to currently be available to the user. Thus, tailoring happens independently of the module calls, so that individual modules do not need to maintain device-specific information.

This filtering is achieved through a module-independent communication object that is filled in by individual modules when they need to communicate with the user. This object has subparts for different forms of media (text, picture, video, audio, etc.). A module fills in as many of these subparts as it is able. The core then mediates the sending of that message to the user, by:
(i) identifying which device the user is currently employing (using a combination of historical usage patterns, presence information, and most recent-communication data);
(ii) mapping the device to a set of media types (so, e.g., an old phone can handle text, a newer device, pictures);
further limiting the media types on the basis of user preferences, and what has been made available by the module; and
initiating the delivery of the appropriate media from the user communication object constructed by the module.

In order to provide representation for a user, an agent must implement a range of functionality. This functionality is gathered together into the core module. Modules can safely make the assumption that the core is available for them to make calls upon.

The core contains a range of specific methods that implement particular components of functionality. These methods can be grouped together into functional groups. Thus the core can be subdivided into discrete areas of functionality. Any module can make a call on any of the methods in any of the areas of the core's functionality via the IMCL. The core provides methods that provide functionality corresponding to a fixed set of labels concerned with generic agent activity. This functionality includes:
1. Belief management (including lookup and update)
2. User profile management (including lookup and update)
3. Agent-User communication
4. Module Management
5. Basic generic reasoning tools
6. Between-Agent Module-Module communication (BAMM) (send and receive)

The agent as a whole is a unitary autonomous software entity, and as such maintains a single, coherent set of tokens representing information about the world.

This belief database is changed through the action of methods in the core. These methods implement core labels for belief update. Any module (including the core itself) can make calls as described herein on these labels through the IMCL.

Similarly, the belief database can be queried by any method through a call to a label mapped through the IMCL to core functionality. Thus a module can perform a lookup on the currently held beliefs by calling this label.

The user profile is a subset of the belief database, and includes information specific to the user across a range of domains. Again, the core implements labels corresponding to update and query to the user profile. There is the potential for the core to update the user profile dynamically in response to user actions—that is, the agent could adapt to and learn the user's preferences as a result of repeated interaction.

User data (e.g., address; credit card details; age) and user preferences (e.g., policy on releasing credit card details; preference for aisle or window seat on planes; preferred DVD supplier) are stored in a local, private, secure database. Both user data and user preferences are extracted in three ways. First, through an explicit online interface that requests input on date of birth, or supports update to reflect change of address. Second, if the agent recognises information that it needs from the user, it can ask for it directly (e.g. asking a yes/no question by SMS). Third, as the user interacts with services manually, the agent can intercept information either explicitly or implicitly. If the user answers a particular question from a particular online service, the agent may either store that answer for future use, or ask the user explicitly if such storage is appropriate or useful. When acting autonomously, the agent provides information that external service requires (and no more), less anything that the user has placed a restriction on. Thus, for example, when interacting with an online newspaper, the newspaper provider may request user registration, but not demand it. In this case, the agent would provide no user information. Alternatively, when interacting with a book e-tailer, the e-tailer may require personal details including credit card data. If the user has instructed his or her agent not to give out credit card details without confirming it first, the agent would halt interaction with that site until user confirmation was sought and agreed.

These components could be represented by the steps:
1. Agent has goal of interacting with a service
2. Select required information from the user model (UM) (accesses the UM)
3. Check that the user model permits all this information to be freely given (accesses the UM)
If so,
4. Information Given to the Service
Otherwise
5. Process the restriction (either by terminating, or by asking the user, or by performing some other action)

The core also includes a subsystem responsible for passing messages to, and receiving messages from the user. The user may connect to his or her agent through a number of different channels: using a web browser on a PC, using a rich media mobile device (a Java phone, for example), using a high capacity mobile device (such as one that uses GPRS), or using older, limited media device (say that can only handle voice and SMS traffic). The core implements labels that handle communication to and from such devices quite transparently: the calling module does not need to specify the different communication types at all.

The means by which one agent communicates with another is implemented in the core. Rather than supporting only agent-to-agent messages, the architecture is instead built around the idea that it is individual modules within agents that communicate with one another (this is “between agent module-module” or BAMM communication). Thus a module with expertise in buying in a particular e-commerce institution will communicate with a module in another agent that has expertise in selling in that same e-commerce institution. The fact that those agents also happen to have modules with expertise in a range of other diverse applications has no impact upon the conversation between buyer and seller in this domain. It is thus modules that structure conversations. The individual utterances (or, more accurately, utterance types) that a module uses to construct a given conversation are common across the entire architecture. The sending and receiving of these individual utterances is co-ordinated by the core.

In this way, a module in an agent can conduct conversations tailored to the domain in which the module has competence. Though the conversation structure is tailored, the implementation of primitive sending and receiving is located in the core. This means that there needs to be only one language definition—the language that agents use for all communication. (If BAMM communication was implemented solely in modules, those modules would, by definition, use their own idiosyncratic languages, and therefore the number of languages would be proportional to the square of the number of module types.) As language design and verification is a labour intensive task, reducing the task by separating primitive semantics from conversation definition, and rendering the former once only in the core, saves a great deal of effort.

The IMCL provides a small number of function calls, the most important of which is the call which effects Within-Agent Module-Module (WAMM) communication. When one module wants to call a method in another module (including a method provided by the core) it calls the IMCL's WAMM communication method, passing it a label. The IMCL then resolves that label by referring to its table of labels.

This means that one module need not know which other module implements the functionality of a given label. Indeed, a module can be implemented in such a way that it can attempt a call on some labelled functionality, but exhibits robustness in the event that no module is present that implements that functionality. (Consider, for example, module x that is, amongst other things, responsible for performing some exponentiation calculation. Module x has two ways of performing the calculation—doing it itself, slowly and laboriously using repeated addition, or by asking a specialised module y that can do exponentiation quickly and efficiently. The problem is that x has no way of knowing whether or not y is installed. Thus x makes a call to the IMCL requesting exponentiation on a particular data set. If y is installed, the IMCL will pass the request to the appropriate method within y. If y is not installed, the IMCL will inform x that no module implements exponentiation and x can then follow the more laborious route of performing the calculation itself). The process by which a label is resolved is summarised in FIG. 3.

With reference to FIG. 3, a module makes a call to label L 310. The IMCL looks up L in a label table 312. If L is not present 314, the IMCL returns “not found” 316. If L is present, and L does have multiple resolutions 318, then the IMCL selects the highest priority resolution 320. Next the IMCL calls the method described in the resolution 322. Finally, when the method returns a value 324, the IMCL passes the return value back to the caller.

A practical advantage of the approach is that it removes compile time dependencies: a module developer can design, implement and test a module which makes calls to another module that they do not have, or do not have access to, or, indeed, that has not been developed at all. This simplifies many of the problems of software engineering in the large, and of multi-site collaborative development work.

With reference to FIG. 4, a flowchart 700 of the module docking process is shown. First, either a user specifies 702 a module, the core receives a message 704 specifying a module to download, or the core determines 706 that a module should be downloaded. The core reasons and decides 708 whether or not to download the module. If a download is determined to be completed, the core calls 710 the IMCL with the getmodule label and URI (Universal Resource Identifier) specifying the location of the Java Archive file (having the jar file extension). If not, the docking process ends 730. The IMCL then resolves 712 the getmodule label to the ModuleManagement.ModuleGet method in the core and the IMCL calls 714 the core's ModuleManagement.ModuleGet method with the URI. ModuleManagement downloads 716 the Java Archive file from the URI. The .jar manifest file 718 specifies the Module class and the Module class 720 includes the DockMe method. With this information, the ModuleManagement instantiates 722 the Module class and calls 724 the DockMe method. The DockMe method may then register 726 labels with the IMCL and initialise 728 the BAMM handler before ending the process 730.

The undocking method of a particular module informs the IMCL and the core module management that the functionality provided by the module is terminating, and then kills the module's thread.

One of the advantages of decoupling of functionality in separate modules is in allowing modules to be added to an agent on-the fly. Such modules need not have functionality that is known before the agent is instantiated, as each module describes its own behaviour and functionality on docking. The same approach can be used to update existing modules with new versions.

Another, practical, advantage of the approach is that it removes compile time dependencies: a module developer can design, implement and test a module which makes calls to another module that they do not have, or do not have access to, or, indeed, that has not been developed at all. This simplifies many of the problems of software engineering in the large, and of multi-site collaborative development work.

The core is responsible for the handling of new modules and module updates. It arranges for outgoing requests to be sent for new modules (or for updated versions of existing modules), handles incoming requests for the agent to take on new modules, and handles the process by which a module is added. So, for example, if the user decides to sign up for a new, free service, the core may send a message to the coordinating agent for that service, requesting the module. After some brief negotiation, the coordinating agent may send back a request to install the new module. The core module management accepts and downloads the software. After updating the internal module database, it starts the new module, which then docks with the IMCL, as described above.

The process of updating a module and the handover between the older and newer versions is illustrated in FIG. 5. With reference to FIG. 5, a flowchart 800 of the module updating process is shown. First, either a user specifies 802 a module, the core receives a message 804 specifying a module to update, or the core-determines 806 that a module should be updated. The core reasons and decides 808 whether or not to update the module. If an update is determined to be completed, the core calls 810 the IMCL with the getmodule label and URI specifying the location of the Java Archive file. If not, the updating process ends 836. The IMCL then resolves 812 updatemodule label to the ModuleManagement.ModuleUpdate method in the core and the IMCL calls 814 the core's ModuleManagement.ModuleGet method with the module name and the URI. ModuleManagement calls 816 the module's UpdateMe method and the UpdateMe method returns the module state information, which is then stored 818 by ModuleManagement. ModuleManagement downloads 820 the Java Archive file from the URI. The jar manifest file 822 specifies the Module class and the Module class 824 includes the DockMe method. With this information, the ModuleManagement instantiates 826 the Module class and calls 828 the DockMe method with the stored state information. The DockMe method may then register 830 labels with the IMCL and initialise 832 the BAMM handler before the Module Management calls 834 the UnDockMe method on the old module and unloads the class then ends the process 836.

The core's module management also handles more complex situations, in which a new version of an existing module is installed. The handover between the modules requires careful timing to ensure service to the rest of the agent are not disrupted. When a new version of a module is to be docked, the core module management calls the old version's update method, and, at an appropriate moment (at a break between discrete tasks that the module is working on) the module returns a representation of its current state.

Then, as part of the new module's docking method, it accepts the state of the previous version's data, so that it can pick up from where the previous module left off.

During the handover between versions of a module, the IMCL queues calls to the modules' labels, awaiting the docking of the new version.

Some of the functionality described herein is collected together in the core. Rather than hardwire a distinction between core and other modules, the core is instead implemented in just the same way as any other module. This means that calls on core functionality can exploit the robustness of the label-based, IMCL-mediated method calling.

It also means that core itself can be updated and docked through just the same process as any other module (so the activity of the module management component in the old core is interrupted and then taken up by the activity of the module management component in the new core). This means that new core functionality can be deployed dynamically, without other modules needing to know ahead of time all that might be included.

Agentative representation in mobile services represent a domain in which persistency is crucial, and quality of service requirements are extremely high (and in some cases, are at safety critical levels). The present invention provides the capability to decouple modules in such a way that both data exchange and method calls can be executed without prior knowledge of anticipated functionality.

In addition, agents can be enabled to be dynamically equipped with behaviours that had no definition at the time those agents were initiated. Furthermore the agents are provided with means for: (i) agent mediation of the update (that is agents communicate between themselves to arrange for update to functionality); (iii) dynamic update of core functionality in exactly the same way as any other module (because core should be treated in the same way as any other module); and (iv) the ability to replace existing functionality in a principled manner, as well as add to it.

Further modifications and improvements may be added without departing from the scope of the invention herein described.

1. A software agent for representing a person's identity, the software agent being adapted to dock a dockable module, the dockable module comprising a method means for performing a function, wherein the software agent further comprises an intermodule communication means for mapping a request from a requesting module to the method means in the dockable module.

2. A software agent as claimed in claim 1 wherein, the method means is adapted to perform said function responsive to said request.

3. A software agent as claimed in claim 1, wherein said request from the requesting module comprises a label specifying a function and said method means in said dockable module corresponds to the specified function.

4. A software agent as claimed in claim 1, wherein said intermodule communication means comprises a store of labels and associated modules.

5. A software agent as claimed in claim 4 wherein said store of labels and associated modules is a table.

6. A software agent as claimed in claim 1, wherein said method means is adapted to perform the function of docking said dockable module with said agent.

7. A software agent as claimed in claim 1, wherein said method means is adapted to perform the function of registering a label with said intermodule communication means, the label specifying a function supported by said dockable module.

8. A software agent as claimed in claim 1, wherein said method means is adapted to perform the function of undocking said dockable module from an agent.

9. A software agent as claimed in claim 1, wherein said method means is adapted to perform the function of requesting to discard a label from the intermodule communication means, the label specifying a function supported by said dockable module.

10. A software agent as claimed in claim 1, wherein said method means is adapted to perform the function of updating said dockable module within said agent.

11. A method of deployment of a module in an agent comprising the steps of:
receiving a request for deployment of said module;
maintaining registration information relating to a function supported by said module; and
invoking said function.

12. A method as claimed in claim 11, wherein, the step of maintaining registration information comprises maintaining a store of labels and associated modules, each label specifying a function supported by a module.

13. A method as claimed in claim 12 wherein said store of labels and associated modules is a table.

14. A method as claimed in claim 11, wherein, the step of maintaining registration information comprises the step of registering a label specifying a function supported by said module.

15. A method as claimed in claim 11, wherein, said module is a docked module and said step of maintaining registration information comprises the step of unregistering a label specifying a function supported by said docked module.

16. A method as claimed in claim 11, wherein said module is a replacement module and said step of maintaining registration information comprises the steps of:
unregistering a label specifying a function supported by a docked module from said agent; and
registering a label specifying a function supported by said replacement module with said agent and said method further comprises the steps of:
storing information related to a state of said docked module; and
instantiating said replacement module using said stored information.

17. A method as claimed in claim 16, wherein, said step of maintaining registration information comprises the step of queuing calls to the docked modules's registered labels, prior to the step of registering the label specifying the function supported by said replacement module.

18. A method as claimed in claim 11, wherein, the function supported by said module is the method of deployment of said module.

19. A computer program comprising program instructions for causing a computer to perform the method of claim 11.
